(19) United States
(12) Patent Application Publication
(10) Pub. No.: US 2006/0021403 A1
(43) Pub. Date: Feb. 2, 2006

(54) Burglarproof lock

(76) Inventor: Cheng-Chi Kuo, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 11/182,746

(22) Filed: Jul. 18, 2005

(30) Foreign Application Priority Data
Jul. 27, 2004 (TW) 093122373

(51) Int. Cl. E05B 15/08

(52) U.S. Cl. 70/454

(57) ABSTRACT

The present invention relates to a [symbol] burglarproof lock [symbol] , comprising a cylinder case, a cylinder lock-core and a key, wherein said cylinder case is a hollow cylinder with cylinder cavity, said cylinder cavity having one end being formed to tightly wrap the periphery of cylinder lock-core, and the opposite distal end being closed plane as top cover, a keyhole is formed at the off-center position on the top cover, and a shift slot is formed in connection with said keyhole in manner of extending towards center of said top cover, and the position of said key-socket and that of keyhole on said top cover of said cylinder case is arranged out of alignment. As put said blade-plug of said key into said keyhole, said thin-shank should be guided into said shift slot and moved transversely along it towards said key-socket until said blade-plug being in alignment with said key-socket on the cylinder lock-core. Then, said blade-plug can be inserted into said key-socket in order to attain the goal of opening the lock. Thus, it has special effect in burglarproof.

### FIELD OF THE PRESENT INVENTION

The present invention relates to originating a Burglarproof Lock and more particularly to one contrived for unshielded lock-core lock, incorporating a hard cylinder case being specifically formed with cylinder lock-core tailored for sheath, and a key being specially devised with elongated thin shank adapted to match it, in order to achieve twofold efficiency in multiple burglarproof functions and difficulty in forging replication.

### BACKGROUND OF THE PRESENT INVENTION

For conventional locks, except few of them are electronic and of chip type, most are mechanical locks, whose core-socket of the lock-core is always open exposed-type. So the user can look it by eyes and insert the key into the core-socket to attain the goal of opening or closing it. Therefore, some sneak thief or burglar can easily open the lock of interest without any obstruction by special lock-opening implements to commit the crime of theft. Recently, some intelligent criminals further make use of the assistance form repairman of lock shop by lying that they have their keys lost in order to get the forging replicated key from the repairman to commit variety of crimes.

All these different illegal or unduly criminal means or behaviors already became a great hidden worry about security of the daily life in society and country. What the causes come from two major factors in key design of exposed-type lock-core said above and easiness in forging replication of the key being coupled the lock. It is always seen that there are, in a short street, some lock shops, which not only render instant service but also provide packaged service of key replication. No wander it is useless even some more padlocks are added thereon and mere formality in expectation of burglarproof from such locks or padlocks.

In view of those drawbacks said above in conventional locks being undesirable, through long-term research and reproduction of trial prototype as well as constant test and amendment, the present invention is originated to achieve the recognizable efficiency.

### SUMMARY OF THE PRESENT INVENTION

The prime object of the present invention is to provide a burglarproof lock, which comprises a cylinder case, a cylinder lock-core and a key with thin shank, wherein said cylinder case is a hollow cylinder with cylinder cavity, said cylinder cavity having one end being formed to tightly wrap the periphery of cylinder lock-core, and the opposite distal end being closed plane as top cover, a keyhole is formed at the off-center position on the top cover, and a shift slot is formed in connection with said keyhole in manner of extending towards center of said top cover, and such that the position of said key-socket on said lock-core and that of keyhole is arranged out of alignment. As put said blade-plug of said key into said keyhole, said thin-shank should be guided into said shift slot and moved transversely along it towards said key-socket until said blade-plug being in alignment with said key-socket on the cylinder lock-core. Then, said blade-plug can be inserted into said key-socket in order to attain the goal of opening the lock. Thus, it has special effect in burglarproof.

The other object of the present invention is to provide a burglarproof lock with a special key. For matching said shift slot on the top cover of cylinder case, a thin shank is formed in the middle section on matching key. And a blade-plug for opening the lock is formed on the front end of said key. Therefore, the design of said key is different from that of conventional locks, and makes it difficult in forging replication on the conventional lock-replicating machine. Thus, it becomes the barrier of the illegal replicated-key.

### BRIEF DESCRIPTION OF THE DRAWINGS

FIG. 1 is a perspective view of the first preferred embodiment of the present invention.

FIG. 2 is a cross-sectional view along the A-A line of FIG. 1.

FIG. 3 is a structure perspective view in the assembly of the case and cylinder core.

FIG. 4 is a sectional view of step-1 in operating mode of the present invention.

FIG. 5 is a sectional view of step-2 in operating mode of the present invention.

FIG. 6 is a sectional view of step-3 in operating mode of the present invention.

FIG. 7 is a perspective-sectional view of one-piece unity formed by the case and cylinder core of the present invention.

FIG. 8 is an elevation-sectional view of FIG. 7.

FIG. 9 is a perspective view of the case with an external flanged fixing base of the present invention.

FIG. 10-A is a perspective view of the present invention applied in padlock with U-shaped shackle.

FIG. 10-B is a partial elevation-sectional view of FIG. 10-A of the present invention.

FIG. 11 is a structure perspective view of the second preferred embodiment of the present invention.

FIG. 12 is a sectional view of step-1 in operating mode of FIG. 11.

FIG. 13 is a sectional view of step-2 in operating mode of FIG. 11.

### DETAILED DESCRIPTION OF THE PREFERRED EMBODIMENT

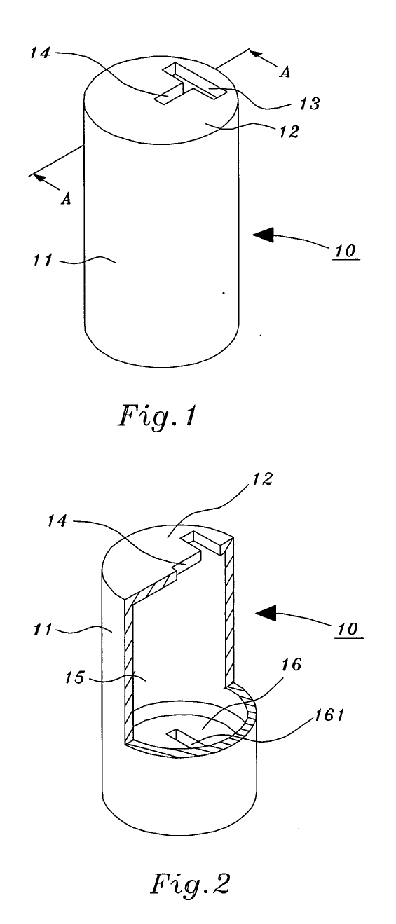

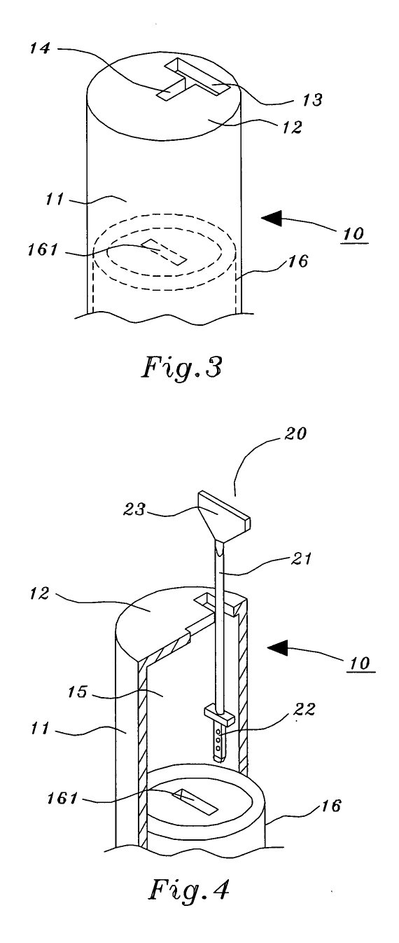

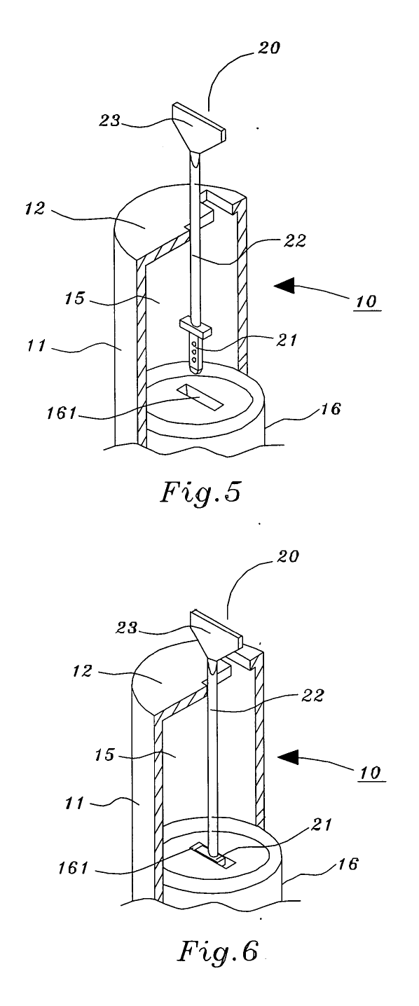

Referring to FIG. 1 to FIG. 6, the Burglarproof Lock 10 in the first preferred embodiment of the present invention comprising a cylinder case 11, a cylinder lock-core 11 and a key 20, wherein said cylinder case 11 is a hollow cylinder with cylinder cavity 15, said cylinder cavity 15 having one end being formed to tightly wrap the periphery of cylinder lock-core 16, and the opposite distal end being closed plane as top cover 12, so that certain space extends between top end of said lock-core 16 and inner closed plane of top cover 12 inside said cylinder cavity 15, a keyhole 13 is formed at the off-center position on the top cover 12, and a shift slot 14 is formed in connection with said keyhole 13 in manner of extending towards center of said top cover 12; said cylinder lock-core 16 is sheathed in said cylinder cavity 15 of said cylinder case 11, a key-socket 161 is formed on the top plane of said cylinder lock-core 16 for inserting key 20, and the position of said key-socket 161 and that of keyhole 13 on said top cover 12 of said cylinder case 11 is arranged out of alignment; said key 20 having a blade-plug 21 at its front end for inserting into key-socket 161 on said cylinder lock-core 16, and having a key-stem 23 at rear end for gripping by fingers, and a thin-shank 22 being elongated between said blade-plug 21 and said key-stem 23 such that the outer diameter of said thin-shank 22 being smaller than the breadth of said shift slot 14 on said top cover 12, and the length of said thin-shank 22 being longer than that between top plane of said cylinder lock-core 16 and closed inner plane of said top cover 12.

Referring to FIG. 4 to FIG. 6, for operation of opening the lock. First, put said blade-plug 21 of said key 20 into said keyhole 13 on said top cover 12 of said cylinder case 11. Secondly, move transversely said middle section thin-shank 22 of said key 20 along said shift slot 14 towards said key-socket 161 until said blade-plug 21 of said key 20 being in alignment with said key-socket 141 on the cylinder lock-core 16. Further, insert said blade-plug 21 of said key 20 into said key-socket 161. Then, grip said key-stem 23 by hand to turn said key 20 properly for handling cylinder lock-core 16 in order to attain the goal of opening the lock.

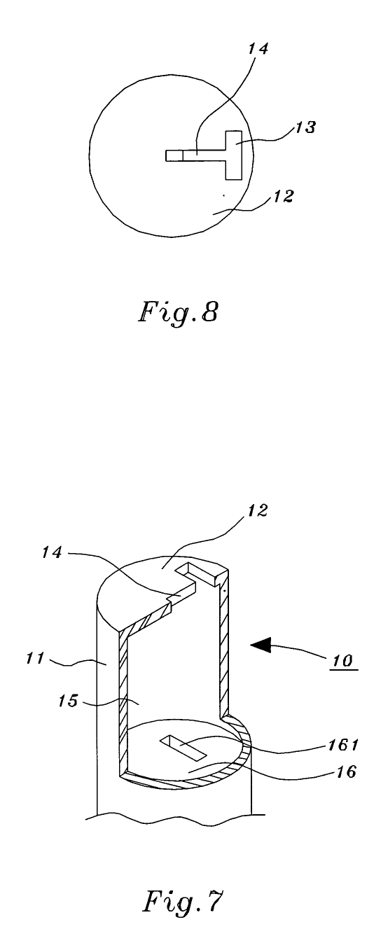

Referring to FIG. 7 and FIG. 8, said cylinder case 11 and said cylinder lock-core 16, which are usually two components respectively, can be formed in one-pieced unity.

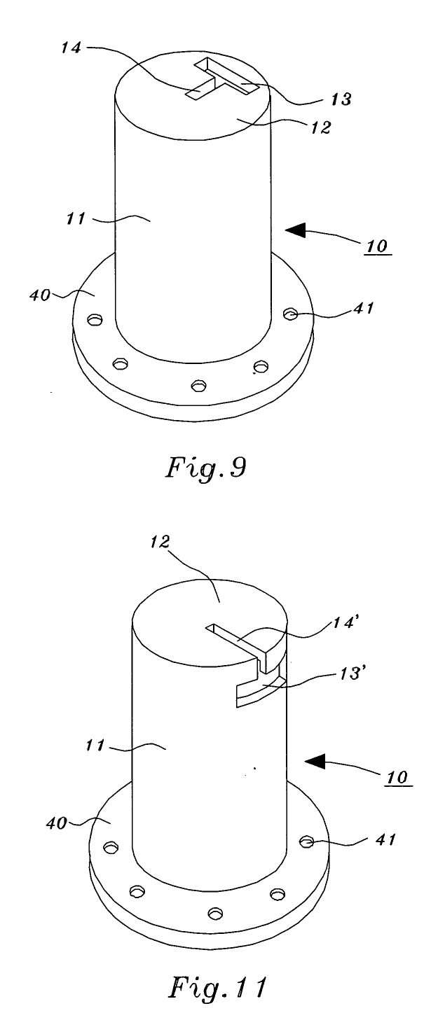

Referring to FIG. 9, a base 40 is externally flanged on the periphery of the opposite distal end of said top cover 12 on said cylinder case 11 of said lock 10 in the present invention. And, there are some fixing holes 41 being formed around the ring of said base 40 for fixing screws to drive through in order to fix whole lock 10 on the door-post, door-stile or other objects.

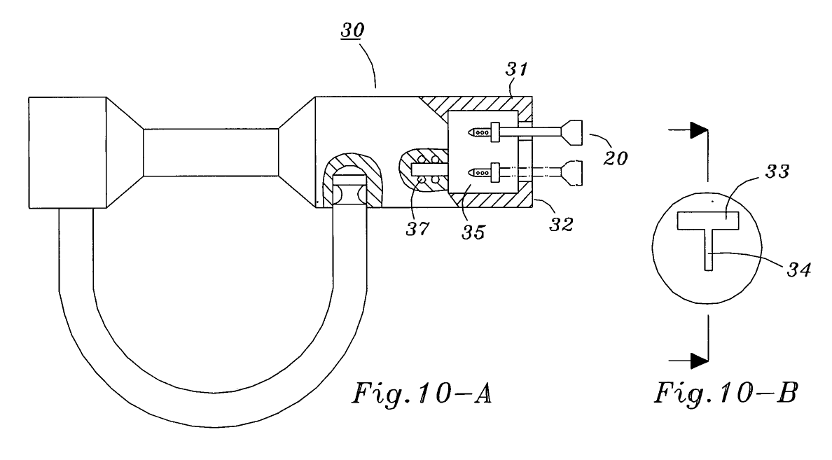

As shown in FIG. 10-A and FIG. 10-B, the configuration of padlock with U-shaped shackle being applied in the present invention. Wherein a cylinder case 31 extends from the distal end periphery of cylinder lock-core 37 of said U-shaped padlock 30, a keyhole 33 and a shift slot 34 are formed on its top cover 32. By means of cylinder cavity 35 between said top cover 32 and cylinder lock-core 37 for key 20 being inserted, the effect of burglarproof is same as that of first preferred embodiment mentioned above.

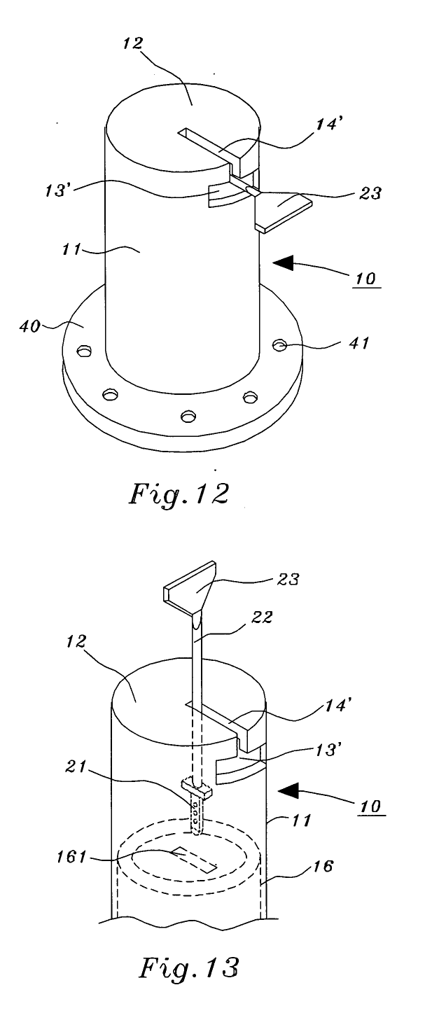

Referring to FIG. 11 to FIG. 13, it is the second preferred embodiment of the present invention. The keyhole 13′ is formed on the lateral side on said cylinder case 11, and the shift slot 14′ is also extended to link said keyhole 23′ in connection manner. Thus, the operation of opening the lock can be adapted into such way of inserting key 20 from side of said cylinder case 11 first, then turn it towards shift slot 14′ until being perpendicularly inserted into the key-socket 161. So that to turn said key 20 properly for handling cylinder lock-core 16 in order to attain the goal of opening the lock as previous two embodiments mentioned above.

In summary, the originating design of the present invention, which makes the position of said exposed keyhole and that of said concealed key-socket arrangement in out of alignment, conforms to the purpose of the invention and the value of industrial application. As it has not only some advantages, such as simple in structure, economical in cost and easy in operation, but also has function of being more effective in expecting burglarproof by means of special design of thin shank in matching key.

What is claimed is:

1. A burglarproof lock, comprising:
a cylinder case, which is a hollow cylinder with cylinder cavity, said cylinder cavity having one end being formed to tightly wrap the periphery of cylinder lock-core, and the opposite distal end being closed plane as top cover, so that certain space extends between top end of said lock-core and inner closed plane of top cover inside said cylinder cavity, a keyhole is formed at the off-center position on the top cover, and a shift slot is formed in connection with said keyhole in manner of extending towards center of said top cover;
a cylinder lock-core, which is sheathed in said cylinder cavity of said cylinder case, a key-socket is formed on the top plane of said cylinder lock-core for inserting key, and the position of said key-socket and that of keyhole on said top cover of said cylinder case is arranged out of alignment; and
a key 20, which has a blade-plug at its front end for inserting into key-socket on said cylinder lock-core, and has a key-stem at rear end for gripping by fingers, and a thin-shank being elongated between said blade-plug and said key-stem.

2. A burglarproof lock as recited in claim 1, wherein said breadth of the shift slot is smaller than that of the keyhole.

3. A burglarproof lock as recited in claim 1, wherein said outer diameter of said thin-shank in the middle section being smaller than the breadth of said shift slot on said top cover. And, said length of said thin-shank being longer than that between top plane of said cylinder lock-core and closed inner plane of said top cover.

4. A burglarproof lock as recited in claim 1, wherein two components of said cylinder case and said cylinder lock-core is formed in one-pieced unity.

5. A burglarproof lock as recited in claim 1, wherein a base is externally flanged on the periphery of said cylinder case. And, there are some fixing holes being formed around the ring of said base.

6. A burglarproof lock as recited in claim 1, wherein said keyhole is formed on the lateral side on sai cylinder case, and the shift slot is formed at the position abutting said keyhole towards the center of said top cover and extended to link said keyhole in connection manner.
